(19) United States
(12) Patent Application Publication
(10) Pub. No.: US 2006/0288207 A1
(43) Pub. Date: Dec. 21, 2006

(54) Encoding messages for use in a communication system based on classificaiton status

(75) Inventors: Michael K. Brown, Kitchener (CA); Herbert A. Little, Waterloo (CA); Michael S. Brown, Waterloo (CA); Michael E. McCallum, Elmira (CA); Scott W. Totzke, Waterloo (CA); Neil P. Adams, Waterloo (CA)

Correspondence Address: NIXON & VANDERHYE, PC, 901 NORTH GLEBE ROAD, 11TH FLOOR, ARLINGTON, VA, 22203, US

(73) Assignee: Research In Motion Limited, Waterloo (CA)

(21) Appl. No.: 11/154,953

(22) Filed: Jun. 17, 2005

(51) Int. Cl. H04L 9/00

(52) U.S. Cl. 713/166

(57) ABSTRACT

A communication system is provided with program logic for enforcing an IT Policy specifying suitable encryption encoding levels for corresponding security classification levels (and/or encryption strengths).

### BACKGROUND

1. Field of Technology

This application generally relates to communication systems capable of encoding messages for security purposes.

2. Related Art

Governments, and some corporations, typically use a security classification system to determine the sensitivity level of information in documents and email. Such security classification system varies between different countries and different organizations.

Once the classification level of information is set, it is important to make sure the appropriate security policies are uniformly always applied. When classifications are applied to email, what is needed is a method to enforce appropriate message encoding based on the classification status set (e.g., classification level, strength of encryption, etc.).

There is a prior solution for adding classification to Outlook (TM owned by Microsoft Corporation) messages. It is called “Classify” and is found on the World Wide Web at “markwilson.ca/products.html”. The product is a plug-in for Outlook™ which allows one to add classification to a message. However, the classification level is not necessarily tied to message encoding. Accordingly, there is no way to enforce, for example, that all “secret” and above messages must be encrypted.

### BRIEF DESCRIPTION OF THE DRAWINGS

Objects and advantages of the approach described herein will be better understood and appreciated in conjunction with the following detailed description of exemplary embodiments taken together with the accompanying drawings, of which:

FIG. 1 is an overall system wide schematic view of an exemplary wireless email communication system incorporating a mobile wireless communication device having enhanced ability to encode messages based on classification status;

FIG. 2 is an abbreviated schematic diagram of hardware included within an exemplary mobile wireless communication device;

FIG. 3 is an exemplary abbreviated schematic flow diagram of computer software (i.e., program logic) that may be utilized in the device of FIG. 2 to enforce an IT Policy of encryption encoding according to classification status (e.g., classification level or encryption strength);

FIG. 4 is a table depicting an exemplary IT Policy for use in the program logic of FIG. 3; and

FIG. 5 is an exemplary abbreviated schematic flow diagram of computer software (i.e., program logic) that may be utilized in the device of FIG. 2 to insure at least a minimum encoding level.

### DETAILED DESCRIPTION OF EXEMPLARY EMBODIMENTS

To solve this problem, we allow the Information Technology (IT) Administrator (through IT Policy) to set a desired mapping between available classification statuses and the corresponding applicable message encoding levels. This could be an explicit mapping (such as “Secret”=“Encrypted”) or it could be a series of minimums (such as “Confidential”>=“Signed”).

This information could, for example, get “pushed” to a remote wireless communication device through such an IT Policy. Once resident on the device, when the user wants to send a message, the device application logic would look at the current classification level set by the user and compare the current message encoding to what it should be based on IT Policy. If it is unspecified, of course, it can just be sent as is. If it is specified, and the encoding currently specified for use is not at least of minimum required strength, the encoding would be automatically bumped up to the appropriate level (i.e., from Plaintext to Signed and Encrypted). Preferably this would be seamless to the user.

This enforced encoding logic also can be made more granular than just specifying the specific message encoding. For example, as a further variation, the IT Administrator could also (or instead) specify a “strength” level to indicate algorithms that should be used for the encryption. For example, a “Secret” classification may correspond to a “Strong” strength which could mean the public key algorithms used must be >=2048 bits and the symmetric algorithm must be AES-192 or above. But “Top Secret” classification may correspond to “Extra Strong” which would mean public key algorithms used must be >=4096 bits and the symmetric algorithm must be AES-256 or above.

These embodiments may be realized in hardware, software or a combination of hardware and software and provide a method for enhancing the ability to encode messages based on classification status (e.g., in a wireless communication device). The exemplary embodiments are realized at least in part, by executable computer program code which may be embodied in physical digital memory media.

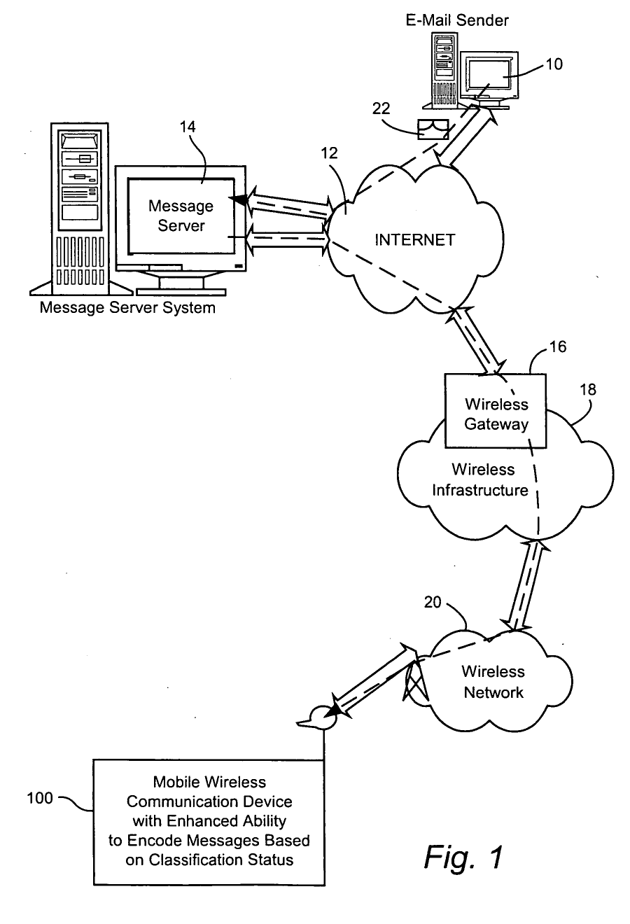

FIG. 1 is an overview of an exemplary communication system in which a wireless communication device 100 may be used. One skilled in the art will appreciate that there may be hundreds of different system topologies. There may also be many message senders and recipients. The simple exemplary system shown in FIG. 1 is for illustrative purposes only, and shows perhaps the currently most prevalent Internet email environment.

FIG. 1 shows an email sender 10, the Internet 12, a message server system 14, a wireless gateway 16, wireless infrastructure 18, a wireless network 20 and a mobile communication device 100.

An email sender 10 may, for example, be connected to an ISP (Internet service Provider) on which a user of the system has an account, located within a company, possibly connected to a local area network (LAN), and connected to the Internet 12, or connected to the Internet 12 through a large ASP (application service provider) such as America Online™ (AOL). Those skilled in the art will appreciate that the systems shown in FIG. 1 may instead be connected to a wide area network (WAN) other than the Internet, although email transfers are commonly accomplished through Internet-connected arrangements as shown in FIG. 1.

The message server 14 may be implemented, for example, on a network computer within the firewall of a corporation, a computer within an ISP or ASP system or the like, and acts as the main interface for email exchange over the Internet 12. Although other messaging systems might not require a message server system 14, a mobile device 100 configured for receiving and possibly sending email will normally be associated with an account on a message server. Perhaps the two most common message servers are Microsoft Exchange™ and Lotus Domino™. These products are often used in conjunction with Internet mail routers that route and deliver mail. These intermediate components are not shown in FIG. 1, as they do not directly play a role in the invention described below. Message servers such as server 14 typically extend beyond just email sending and receiving; they also include dynamic database storage engines that have predefined database formats for data like calendars, to-do lists, task lists, email and documentation.

The Wireless gateway 16 and infrastructure 18 provide a link between the Internet 12 and wireless network 20. The wireless infrastructure 18 determines the most likely network for locating a given user and tracks the users as they roam between countries or networks. A message is then delivered to the mobile device 100 via wireless transmission, typically at a radio frequency (RF), from a base station in the wireless network 20 to the mobile device 100. The particular network 20 may be virtually any wireless network over which messages may be exchanged with a mobile communication device.

As shown in FIG. 1, a composed email message 22 is sent by the email sender 10, located somewhere on the Internet 12. This message 22 typically uses traditional Simple Mail Transfer Protocol (SMTP), RFC 822 headers and Multipurpose Internet Mail Extension (MIME) body parts to define the format of the mail message. These techniques are all well known to those skilled in the art. The message 22 arrives at the message server 14 and is normally stored in a message store. Most known messaging systems support a so-called “pull” message access scheme, wherein the mobile device 100 must request that stored messages be forwarded by the message server to the mobile device 100. Some systems provide for automatic routing of such messages which are addressed using a specific email address associated with the mobile device 100. In a preferred embodiment, messages addressed to a message server account associated with a host system such as a home computer or office computer which belongs to the user of a mobile device 100 are redirected from the message server 14 to the mobile device 100 as they are received. Messages will typically be encrypted from sender to receiver by utilizing a key that is unique to a given device. Examples of two commonly used methods are the Data Encryption Standard (Triple—DES) and the Advanced Encryption Standard (AES).

Regardless of the specific mechanism controlling forwarding of messages to mobile device 100, the message 22, or possibly a translated or reformatted version thereof, is sent to wireless gateway 16. The wireless infrastructure 18 includes a series of connections to wireless network 20. These connections could be Integrated Services Digital Network (ISDN), Frame Relay or Ti connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Division Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric network include the Mobitex™ Radio Network and the DataTAC™ Radio Network. Examples of older voice-centric data networks include Personal Communication Systems (PCS) networks like GSM, and TDMA systems.

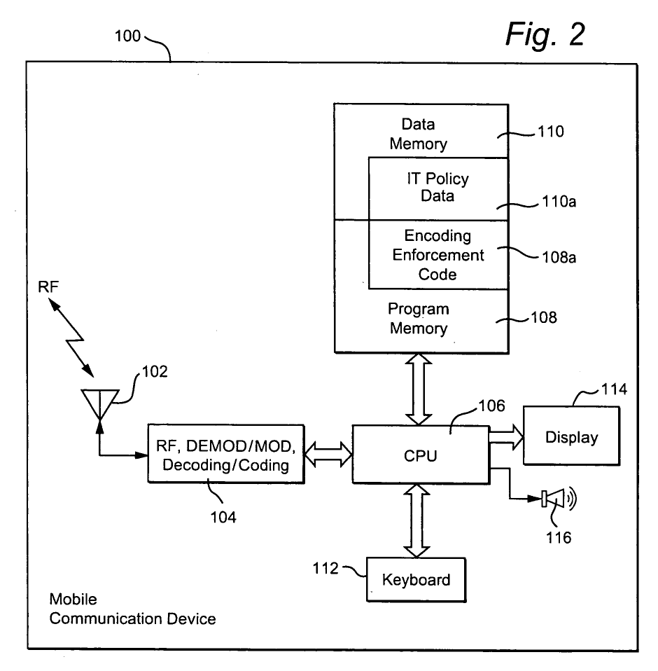

As depicted in FIG. 2, mobile communication device 100 includes a suitable RF antenna 102 for wireless communication to/from wireless network 20. Conventional RF, demodulation/modulation and decoding/coding circuits 104 are provided. As those in the art will appreciate, such circuits can involve possibly many digital signal processors (DSPs), microprocessors, filters, analog and digital circuits and the like. However, since such circuitry is well known in the art, it is not further described.

The mobile communication device 100 will also typically include a main control CPU 106 which operates under control of a stored program in program memory 108 (and which has access to data memory 110). CPU 106 also communicates with a conventional keyboard 112, display 114 (e.g., an LCD) and audio transducer or speaker 116. A portion of data memory 110a is available for storing IT Policy data used to control associated device operations. Suitable computer program executable code is stored in portions of program memory 108a to constitute the program logic for enforcing the IT Policy insofar as encoding according to message classification status capability is described below.

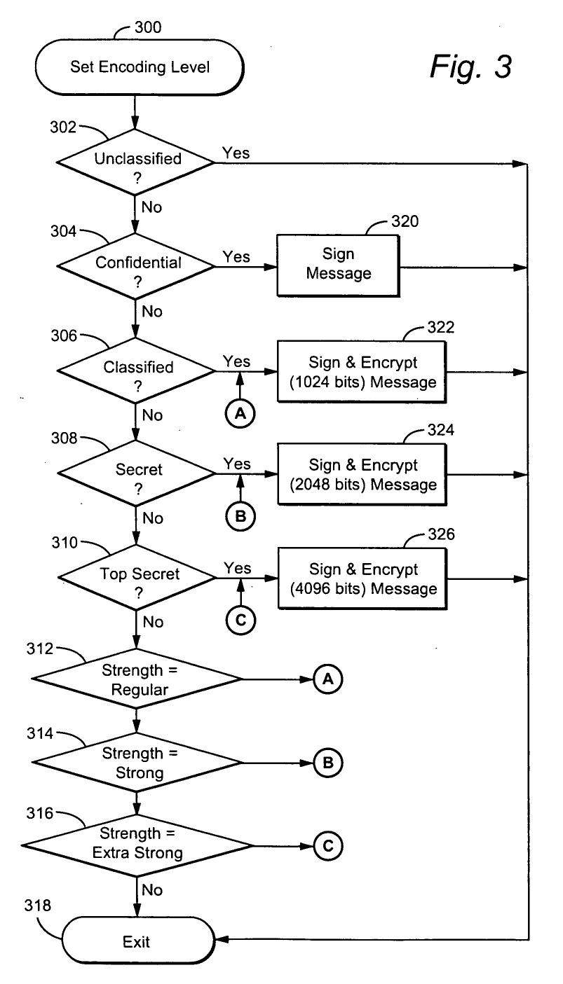

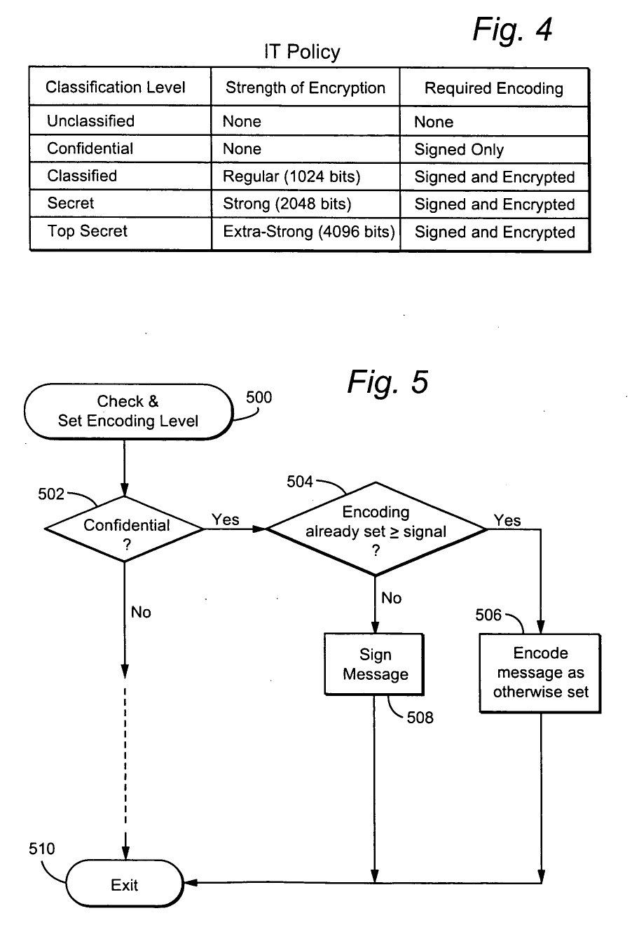

One exemplary encoding enforcement logic is depicted at FIG. 3. Here the “Set Encoding Level” routine 300 may be entered in any desired fashion. For example, it may be manually entered when a user manually sets a classification level or encryption strength parameter. Alternatively, this logic may be forcibly entered as a part of and prior to a message transmission sequence so that it is necessarily traversed for every message generated and/or transmitted from device 100. The logic itself as well as an associated IT Policy (e.g., see FIG. 4) may be downloaded from an enterprise base station (again possibly forcibly “pushed” into every enterprise user device 100).

Suitable tests are made at decision points 302, 304, 306, 308, 310, 312, 314 and 316 to automatically detect which one of plural possible classification statuses have been associated with the message at hand. As will be appreciated, a code representing a particular classification status (i.e., classification level or strength of encryption) can be realized as a field appended to the body or header of a given message. Alternatively, a separate table or database of classification statuses may be maintained in association with other unique message identification data (e.g., sequential serial message numbers or the like). As will be appreciated, the number of decision points will depend upon the number of different classification statuses that are permitted in accordance with a given IT Policy.

In accordance with the IT Policy set forth at FIG. 4, if the message is associated with an unclassified classification level or no strength of encryption, then the routine will be exited at 318 without any special encryption coding requirement. However, in accordance with the IT Policy of FIG. 4, if a classification level of “confidential” is detected at 304, then the message is merely signed at 320 before exit of the sub-routine is taken at 318. However, if the classification status of “classified” or “regular” encryption strength is detected, then the message is signed and encrypted with a 1024 bit encryption key at 322 before the sub-routine is exited at 318. Similarly, if a classification level of “secret” or an encryption strength of “strong” is detected, then the message is signed and encrypted using a longer (e.g., 2048 bit) key at 324. Finally, if a classification level of “top secret” or an encryption strength of “extra strong” is detected, then the message is signed and encrypted with a yet more secure longer 4096 bit encryption key at 326.

If it is only desired to insure at least a minimum encoding level (i.e., to permit higher than minimum encoding levels if otherwise set by the user or system), then an exemplary “Check and Set” encoding level routine 500 is depicted at FIG. 5 (e.g., that may be used as an alternate to the routine of FIG. 3). Here, upon entry at 500, a test is made at 502 for a particular classification status (e.g., perhaps a classification level or an encoding strength level). If that particular status is detected at 502, then another test is made at 504 to see if the encoding level already associated with the message at hand is at least at the minimum corresponding encoding level. If so, then the message may be encoded at 506 using whatever encoding level has already been assigned to that message. However if the minimum encoding level (e.g., in accordance with an imposed IT Policy) has not already been satisfied, then the minimum encoding level is used to encode the message at 508 before exit is taken at 510. As those in the art will appreciate, as many similar subsets of code as desired may be utilized for each possible classification status.

As those in the art will appreciate, there may be many variations and modifications of the above described exemplary embodiments which yet retain some or all of the novel features and advantages of these embodiments. Accordingly, all such modifications and variations are intended to be included within the scope of the appended claims.

What is claimed is:

1. A method for automatically applying appropriate encoding of classified messages in a communication system, said method comprising:
before transmitting a message, detecting at least one of plural possible classification statuses associated with the message; and
automatically and selectively encoding the message for transmission using, if applicable, an encryption encoding level that corresponds to the detected classification status.

2. A method as in claim 1 wherein said classification status associated with a message is manually set by a user.

3. A method as in claim 1 wherein the correspondence between classification statuses and encoding levels is set and automatically enforced on a user by an IT Policy residing in a device used for generating and/or transmitting the message.

4. A method as in claim 1 wherein the classification statuses comprise encryption strength descriptors.

5. A method as in claim 1 wherein the classification levels comprise security level descriptors.

6. A method as in claim 1 wherein the utilized encoding level is at least a minimum encryption encoding level for the detected classification status but may be of a higher level if otherwise designated.

7. Apparatus for automatically applying appropriate encoding of classified messages in a communication system, said apparatus comprising:
means for detecting, before transmitting a message, at least one of plural possible classification statuses associated with the message; and
means for automatically and selectively encoding the message for transmission using, if applicable, an encryption encoding level that corresponds to the detected classification status.

8. Apparatus as in claim 7 wherein said classification status associated with a message is manually set by a user.

9. Apparatus as in claim 7 wherein the correspondence between classification statuses and encoding levels is set and automatically enforced on a user by an IT Policy residing in a device used for generating and/or transmitting the message.

10. Apparatus as in claim 7 wherein the classification statuses comprise encryption strength descriptors.

11. Apparatus as in claim 7 wherein the classification levels comprise security level descriptors.

12. Apparatus as in claim 7 wherein the utilized encoding level is at least a minimum encryption encoding level for the detected classification status but may be of a higher level if otherwise designated.

13. A digital storage medium having stored therein a computer program which, when executed, automatically causes appropriate encoding of classified messages in a communication system, by:
before transmitting a message, detecting at least one of plural possible classification statuses associated with the message; and
automatically and selectively encoding the message for transmission using, if applicable, an encryption encoding level that corresponds to the detected classification status.

14. A digital storage medium as in claim 13 wherein said classification status associated with a message is manually set by a user.

15. A digital storage medium as in claim 13 wherein the correspondence between classification statuses and encoding levels is set by automatically enforced on a user by an IT Policy residing in a device used for generating and/or transmitting the message.

16. A digital storage medium as in claim 13 wherein the classification statuses comprise encryption strength descriptors.

17. A digital storage medium as in claim 13 wherein the classification levels comprise security level descriptors.

18. A digital storage medium as in claim 13 wherein the utilized encoding level is at least a minimum encryption encoding level for the detected classification status but may be of a higher level if otherwise designated.
